(19) United States
(12) Patent Application Publication
(10) Pub. No.: US 2009/0000215 A1
(43) Pub. Date: Jan. 1, 2009

(54) Article for Providing a Barrier

(75) Inventors: Ian Keith Francis, Queensland (AU); Ian Fleetwood Hendry, Queensland (AU)

Correspondence Address: PATENT ADMINISTRATOR;FMC CORPORATION, 1735 MARKET STREET, PHILADELPHIA, PA, 19103, US

(73) Assignee: FMC AUSTRALASIA PTY LTD, Murarrie, Queensland (AU)

(21) Appl. No.: 11/817,849

(22) PCT Filed: Mar. 6, 2006
(86) PCT No.: PCT/AU2006/000291

§ 371 Date: Jul. 17, 2008

(30) Foreign Application Priority Data
Mar. 8, 2005 (AU) 2005901087

(51) Int. Cl. E04B 1/72; A01N 53/10; A01N 53/06

(52) U.S. Cl. 52/101; 424/405; 514/531

(57) ABSTRACT

An article (11) for providing a physical and chemical barrier to impede the penetration of insects through a passageway in a concrete slab (20), the article being adapted to reside in the passageway, between the slab and a member extending through the passageway.

### FIELD OF THE INVENTION

The present invention relates to articles for providing barriers to impede the penetration of insects through a passageway in a concrete slab.

### BACKGROUND TO THE INVENTION

Underlying many houses, as part of the foundations, is a concrete slab. In addition to its structural purpose, one of the functions of the concrete slab is to prevent entry of insects, particularly termites, into the house from the ground. It achieves this by acting as a physical barrier through which the termites cannot eat or burrow.

However, passageways are required through the concrete slab to allow for pipes, such as sewerage pipes and water pipes to extend therethrough. However, such passageways provide a path through which termites may attack a house as they can move through any gap between the slab and the penetrating pipes.

Conventionally, protection against this has been provided by the insertion or placement of some kind of physical barrier between the concrete slab and the penetrating pipe. Commonly, articles referred to as “collars” are used to provide such barriers. Collars are available in many different shapes, but typically have a tubular portion which is shaped to fit around the penetrating pipe and some kind of protrusion from the tubular portion to lock the collar into the concrete slab.

The collars are generally manufactured from a plastic material such as PVC or high density polyethylene.

A problem with these collar barriers is that some species of termites can attack the plastic collars, thus breaking down the physical barrier that they provide.

Another problem with such collar barriers is that they may not be sized sufficiently accurately relative to the penetrating pipe, leaving a gap therebetween. As they rely on a physical barrier to work, any gap in the barrier will render it ineffective.

### SUMMARY OF THE INVENTION

According to an aspect of the present invention there is provided an article for providing a physical and chemical barrier to impede the penetration of insects through a passageway in a concrete slab, the article being adapted to reside in the passageway, between the slab and a member extending through the passageway.

Typically, the member will be a pipe or conduit but could take other forms, such as a cable.

Preferably, the article also provides a repellent barrier in addition to a physical and chemical barrier.

The article may be referred to as a “collar barrier”.

Preferably, the article is manufactured from a plastic containing at least one insecticide.

Preferably, the plastic is any synthetic or semi-synthetic compound formed by organic condensation or polymerisation.

Preferably, the plastic is any plastic which can be moulded or extruded into objects or films or fibres.

Preferably, the plastic is any one or combination of polyamide (nylon), polyethylene, polystyrene, polyvinylchloride synthetic rubber (for example neoprene), polymethacrylate (acrylic), polypropylene and polyurethane.

Preferably, the plastic is high density polyethylene.

Preferably, the article contains a UV stabiliser.

Preferably, the article contains a blue colouring agent.

Preferably, the article is substantially impermeable to water.

Preferably, the at least one insecticide is any compound that exhibits sufficient lethal control and/or repellent effects against insects.

Alternatively, a separate repellent compound in addition to the at least one insecticide may be contained in the plastic.

Preferably, the at least one insecticide is any one or combination of pyrethrin, synthetic pyrethroids, organo-chlorines, organo-sulfurs, carbamates, organo-phosphates, formamidines, nicotinoids, spinosyns, phenyl pyrazoles, pyrroles, pyrazoles, dinitrophenols, pyridazinones, quinazolines and benzoylureas.

Typically, the insects impeded by the article will be termites.

Preferably, the at least one insecticide is a termiticide.

Preferably, the termiticide is a synthetic pyrethroid.

Preferably, the termiticide is any one or combination of bifenthrin, permethrin, deltamethrin, lambda-cyhalothrin, cypermethrin, alphacypermethrin, tetramethrin and cyfluthrin or any other synthetic pyrethroid.

Preferably, the at least one insecticide is bifenthrin.

Preferably, the insecticide and/or repellent are distributed through the plastic.

Preferably, the insecticide does not significantly leach from the plastic. Thus, its activity is expressed through the plastic matrix.

Preferably, the repellent does not significantly leach from the plastic.

Preferably, the concentration of insecticide in the plastic is less than 5 wt %.

Preferably, the concentration of insecticide in the plastic is greater than 0.01 wt %.

Where the insecticide is bifenthrin, its concentration in the plastic is preferably 0.05-1.0 wt %. Preferably, the bifenthrin has a concentration of 0.05-0.1 weight %, more preferably, approximately 0.1 wt %.

In use, the insecticide provides the chemical barrier and may also provide the repellent barrier. Bifenthrin provides a repellent barrier as well as a chemical barrier to the penetration of insects.

When present, the repellent, in use, provides the repellent barrier.

Preferably, the article is formed in a blow moulding process.

Preferably, the article is formed from a master batch of plastic containing insecticide.

Preferably, the master batch has a concentration of insecticide which is stably supported in the plastic.

The article is not limited to any specific shape but generally has a tubular body, which is hollow so that the article, in use, may snugly fit around the member.

Preferably, the fit between the tubular body and the member is a sufficiently tight fit to provide the physical barrier.

Various sized articles may be provided to be used with different sized pipes. The diameter of these different sized articles are typically 25, 40, 50, 80 and 100 mm.

Alternatively, a single sized article may be provided, in which case the article also comprises inserts of various thicknesses to be placed inside the tubular body as required depending on the size of the member.

### BRIEF DESCRIPTION OF THE DRAWINGS

A preferred embodiment of the present invention will now be described, by way of example only, with reference to the accompanying drawings, in which:

FIG. 1 is a perspective view of an article for providing a barrier according to a preferred embodiment of the present invention;

FIG. 2 is a side view of the article of FIG. 1; and

FIG. 3 is a schematic side view of the article of FIG. 1 positioned in use.

### DETAILED DESCRIPTION OF THE PREFERRED EMBODIMENT

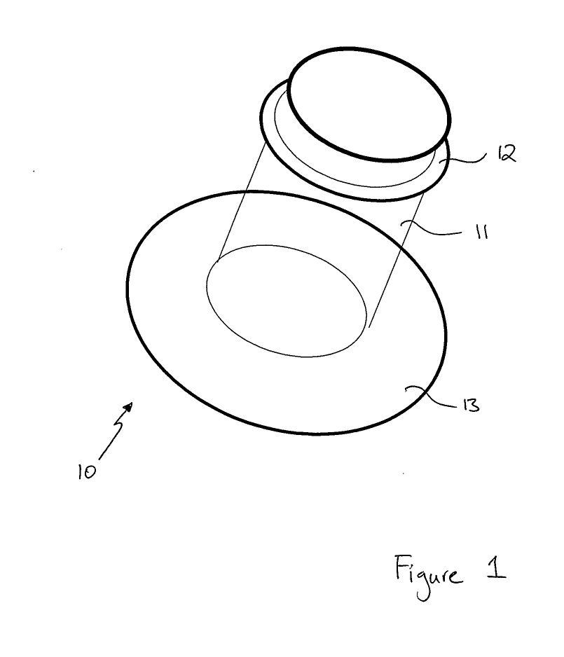

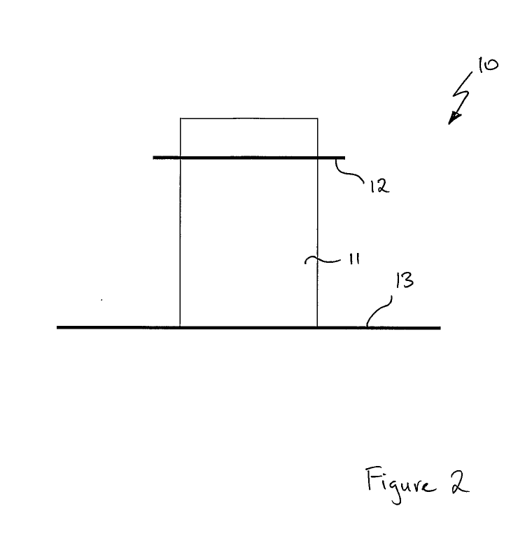

Referring to FIGS. 1 and 2, an article 10, herein referred to as a “collar barrier”, and used to provide a barrier to impede the penetration of insects through a concrete slab, is illustrated. As will become apparent from the description below, the collar barrier 10 provides a physical and chemical barrier to impede the penetration of insects by virtue of the fact that it is manufactured from a plastic having an insecticide dispersed therethrough. The collar barrier 10 may also provide a repellent barrier, ie. will repel insects away from its location in the concrete slab, if the plastic it is manufactured from also has a repellent dispersed therethrough.

Furthermore, the collar barrier 10 is impermeable to water and and can therefore, also provide a moisture barrier.

The plastic from which the collar barrier 10 is manufactured may be any synthetic of semi-synthetic compound formed by organic condensation or polymerisation that can be moulded or extruded into objects or films or fibres. Such compounds include, but are not limited to, polyamide (nylon), polyethylene, polystyrene, polyvinylchloride, synthetic rubber (for example neoprene), polymethacrylate (acrylic), polypropylene and polyurethane. The plastic may be formed from a combination of two or more of these compounds. The preferred plastic used is high density polyethylene.

The plastic may contain a UV stabiliser to prevent break down of the plastic when exposed to sunlight. This is important in maintaining the longevity of the collar barrier 10 which may be in use for up to 50 or more years. The plastic may also comprise a blue colouring agent so that the collar barrier 10 is blue in colour.

The insecticides which are mixed through the plastic may be any compound that exhibits sufficient control and/or repellent effects against insects, particularly termites. Such compounds include, but are not limited to, pyrethrin, synthetic pyrethroids, organo-chlorines, organo-sulfurs, carbamates, organo-phosphates, formamidines, nicotinoids, spinosyns, phenyl pyrazoles, pyrroles, pyrazoles, dinitrophenols, pyridazinones, quinazolines and benzoylureas. Preferably, a noted termiticide or a combination of termiticides is used, such as bifenthrin, permethrin, deltamethrin, lambda-cyhalothrin, cypermethrin, alphacypermethrin, tetramethrin and cyfluthrin or any other synthetic pyrethroid. Some of the aforementioned insecticide compounds may also provide a repellent effect, thereby creating the repellent barrier referred to above.

Typically, the concentration of insecticide in the plastic is less than 5 wt % and greater than 0.01 wt %. The concentration of insecticide is dependant on the actual compound used. If the insecticide is bifenthrin, for example, then the concentration of the insecticide (bifenthrin) in the plastic is 0.05 to 1.0 wt %, preferably 0.05-0.1 weight % and more preferably approximately 0.1 weight %.

Notably, bifenthrin provides a repellent barrier as well as a chemical barrier to the penetration of insects.

Manufacture of the collar barrier 10 involves mixing the insecticide with polymer resin to form a “mater batch”. The master batch has a higher concentration of insecticide than the end collar barrier 10 product. The concentration of insecticide in the master batch may be as high as is stably supported in the polymer matric (ie. does not react and/or leach from the plastic.

For the collar barrier 10 of the preferred embodiment where the insecticide is bifenthrin, mixing the insecticide with polymer resin to form the master batch, in one embodiment involdes melting solid bifenthrin (>99% purity), melting the polymer resin (preferably low density polyethylene) separately and melting the polymer resin and bifenthrin melts. Alternatively, powdered bifenthrin (mixed with talcum powder) or a solution of bifenthrin may be mixed with molten polymer resin to form the master batch. In a preferred embodiment, the concentration of bifenthrin in the master batch is approximately 2 weight %. However, the concentration of bifenthrin in the master batch may be substantially higher.

The master batch is solidified and formed into pellets, awaiting later dilution to achieve the desired concentration of insecticide for the end collar barrier 10 product. Dilution of the master batch occurs by mixing the solid master batch pellets with solid polymer pellets to form a homogenous solid mixture. The homogenous solid mixture is melted and then formed into the collar barrier 10 by any suitable means.

In one preferred embodiment, the collar barrier 10 is formed by blow moulding the molten homogenous mixture of plastic and insecticide.

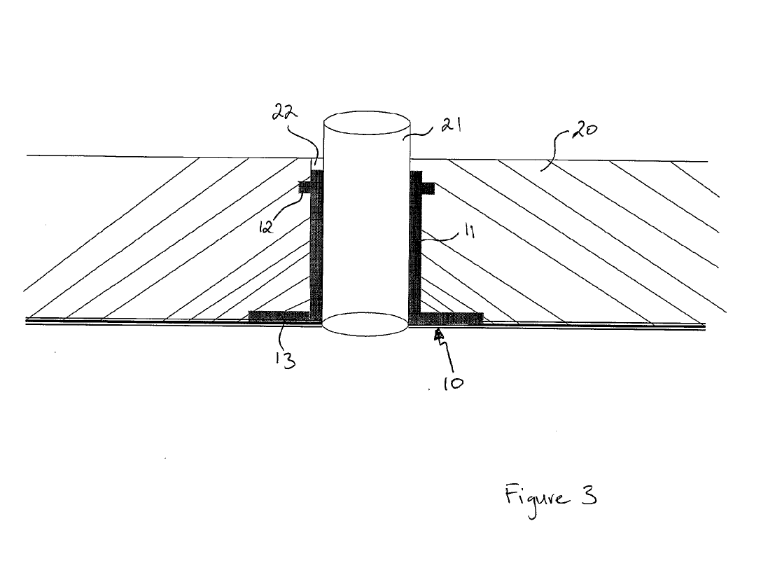

The collar barrier 10 of the present invention is not limited to any particular shape, however it is generally of the design shown in the Figures. The collar barrier 10 comprises a tubular body 11, a slab key flange 12 extending from the tubular body 11 and a base flange 13 also extending from the tubular body 11. The width of the base flange 13 is much greater than the slab key flange 12. The tubular body 11 is hollow so that it can fit around a penetrating pipe 21 (see FIG. 3). This should preferably be a tight fit so as to form the physical barrier. The base flange 13 is located at one end of the tubular body 11.

Referring to FIG. 3, the collar barrier 10 is shown in use. A concrete slab 20 has the penetrating pipe 21 extending through a passageway 22. It is noted that the pipe 21 could be another type of member such as a cable. The collar barrier 10 is located in the passageway 22, between the slab 20 and the penetrating pipe 21. The internal wall of the tubular body 11 of the collar barrier 10 has a tight fit with the penetrating pipe 21.

The base flange 13 is flush with the bottom of the concrete slab 20 so as to assist in impeding insect entry to the passageway 22. The slab key flange 12 extends into the concrete slab 20 so as to “lock” the collar barrier 10 in place relative to the slab 20.

Thus, in use, the collar barrier 10 creates a physical barrier against penetration of insects through the concrete slab 20 by blocking off the space between the space in the passageway 22 between the penetrating pipe 21 and the concrete slab 20. The chemical barrier is provided by the insecticide dispersed therethrough the plastics material from which the collar barrier 10 is manufactured. The insecticide does not significantly leach from the plastic, but instead is retained, and its activity is expressed, through the plastic matrix. Because the insecticide's activity is expressed within the plastic it does not require a substrate such as soil to leach into in order for the collar barrier 10 to work effectively. If termites were to attack the collar barrier 10, then any contact or ingestion of the insecticide-containing plastic will kill the termites. This is because although the insecticide is tightly bound in the plastic and is not dislodged by water, there is still enough insecticide available to deliver a lethal dose to an insect, which picks insecticide up upon contact with the collar barrier 10. Only a tiny amount of insecticide is required to kill the insect.

Similarly, the repellent barrier is provided by a repellent compound dispersed through the plastic from which the collar barrier 10 is manufactured. The repellent chemical also does not leach significantly from the plastic. The advantage of having a repellent barrier is to repel termites away from the passageway 22 even if there is a gap between the collar barrier 10 and the penetrating pipe 21.

The collar barrier 10 may be manufactured in a range of sizes to suit alternative size passageways 22. The diameters of the tubular body 11 of these different sized collar barriers 10 are typically 25, 40, 50, 80 and 100 mm. Alternatively, a stock collar size could be provided, with inserts (not shown) of various thicknesses. The inserts could then be placed inside the tubular body 11 as required depending on the size of the penetrating pipe 21.

In the preceding description of the invention, except where the context requires otherwise due to express language or necessary implication, the word “comprise” or variations such as “comprises” or “comprising” is used in an inclusive sense, ie. to specify the presence of the stated features but not to preclude the presence or addition of further features in various embodiments of the invention.

1. An article for providing a physical and chemical barrier to impede the penetration of insects through a passageway in a concrete slab, the article being adapted to reside in the passageway, between the slab and a member extending through the passageway.

2. An article as claimed in claim 1, wherein the article is manufactured from a plastic containing at least one insecticide.

3. An article as claimed in claim 2, wherein the plastic is any synthetic or semi-synthetic compound formed by organic condensation or polymerisation.

4. An article as claimed in claim 2, wherein the plastic is any one or combination of polyamide (nylon), polyvinylchloride, polyethylene, polystyrene, synthetic rubber (for example neoprene), polymethacrylate (acrylic), polypropylene and polyurethane.

5. An article as claimed in claim 2, wherein the plastic is high density polyethylene.

6. An article as claimed in any one of claims 2 to 5, wherein the at least one insecticide is any compound that exhibits sufficient lethal control and/or repellent effects against insects.

7. An article as claimed in any one of claims 2 to 5, wherein the at least one insecticide is any one or combination of pyrethrin, synthetic pyrethroids, organo-chlorines, organo-sulfurs, carbamates, organo-phosphates, formamidines, nicotinoids, spinosyns, phenyl pyrazoles, pyrroles, pyrazoles, dinitrophenols, pyridazinones, quinazolines and benzoylureas.

8. An article as claimed in any one of claims 2 to 5, wherein the at least one insecticide is bifenthrin.

9. An article as claimed in claim 8, wherein the concentration of bifenthrin is 0.05 to 1.0 wt %.

10. An article as claimed in claim 8, wherein the concentration of bifenthrin is approximately 0.1 wt %.

11. An article as claimed in any one of claims 2 to 10, wherein the insecticide does not significantly leach from the plastic.

12. An article as claimed in any one of the preceding claims, wherein the article contains a UV stabiliser.

13. An article as claimed in any one of the preceding claims, wherein the article is substantially impermeable to water.
